(19) United States
(12) Patent Application Publication
(10) Pub. No.: US 2016/0269053 A1
(43) Pub. Date: Sep. 15, 2016

(54) FRONT END MODULE AND COMMUNICATIONS MODULE INCLUDING THE SAME

(71) Applicant: SAMSUNG ELECTRO-MECHANICS CO., LTD., Suwon-si (KR)

(72) Inventor: Hyun Jun Lee, Suwon-si (KR)

(73) Assignee: SAMSUNG ELECTRO-MECHANICS CO., LTD., Suwon-si (KR)

(21) Appl. No.: 14/992,182

(22) Filed: Jan. 11, 2016

(30) Foreign Application Priority Data
Mar. 13, 2015 (KR) 10-2015-0035217

(51) Int. Cl. H04B 1/00

(52) U.S. Cl. CPC H04B 1/0057

(57) ABSTRACT

A front end module including an antenna configured to transmit and receive radio frequency signals; a diplexer configured to separate the radio frequency signals transmitted and received through the antenna into different frequency bands; a filter connected to the diplexer; and an inductor circuit comprising at least two inductors respectively disposed between an end of the filter and a ground.

### CROSS-REFERENCE TO RELATED APPLICATION

This application claims the benefit under 35 USC 119(a) of Korean Patent Application No. 10-2015-0035217 filed on Mar. 13, 2015, in the Korean Intellectual Property Office, the entire disclosure of which is incorporated herein by reference for all purposes.

### BACKGROUND

1. Field

The present disclosure relates to a front end module and a communications module including the same.

2. Description of Related Art

Along with developments in wireless communications technologies, various communications standards have been simultaneously implemented in one communications device. For example, in a case of Wi-Fi, a new 802.11 ac scheme in a band of 5 GHz as well as the existing 802.11a/b/g/n schemes in a band of 2.4 GHz are applied to one communications device.

When a new communications standard is applied to a communications device, a diplexer is installed in a front end module in order to separate a band of the new communications standard from a band of an existing communications standard. Recently, in accordance with the expansion of a long term evolution (LTE) band, a film bulk acoustic resonator (FBAR) filter has been additionally installed in order to decrease interference between adjacent channels of Wi-Fi and LTE bands.

However, in a case in which the FBAR filter is installed, a bypass path of electrostatic discharge (ESD) cannot be secured, and thus a communications device is vulnerable to the ESD, and impedances may not be matched to each other due to parasitic capacitance present on an FBAR board.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a front end module having an electrostatic discharge (ESD) path secured and impedances of radio frequencies matched to each other, and a communications module including the same. the front end module includes an antenna configured to transmit and receive radio frequency signals; a diplexer configured to separate the radio frequency signals transmitted and received through the antenna into different frequency bands; a filter connected to the diplexer; and an inductor circuit comprising at least two inductors respectively disposed between an end of the filter and a ground.

In another general aspect, a communications module includes a front end module having an antenna configured to transmit and receive radio frequency signals, a diplexer configured to separate the radio frequency signals into different bands, a filter connected to the diplexer, and an inductor circuit comprising at least two inductors each disposed between an end of the filter and a ground; and an integrated circuit connected to the front end module.

Other features and aspects will be apparent from the following detailed description, the drawings, and the claims.

### BRIEF DESCRIPTION OF DRAWINGS

FIG. 1 is a block diagram of an example of a communications module;

FIG. 2 is a block diagram illustrating the communications module of FIG. 1 in more detail;

FIGS. 3A and 3B are Smith charts illustrating impedance matching characteristics of an example inductor circuit;

FIG. 4 is a graph illustrating improvement of insertion loss characteristics by the example inductor circuit; and

FIG. 5 is a graph illustrating improvement of return loss characteristics by the example inductor circuit.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

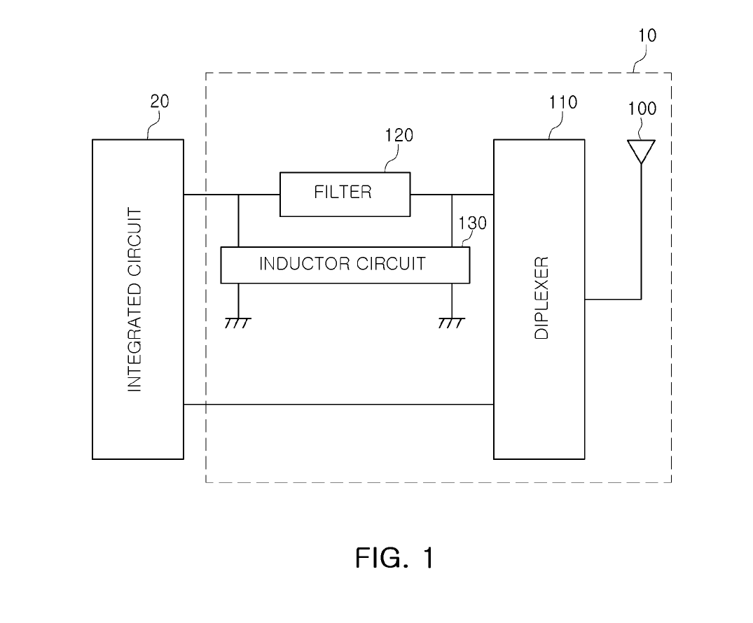

Referring to FIG. 1, the communications module includes a front end module 10 and an integrated circuit (IC) 20. The front end module 10 includes an antenna 100, a diplexer 110, a filter 120, and an inductor circuit 130.

The antenna 100 transmits and receives radio frequency signals. The antenna 100 receives radio frequency signals broadcasted from an external source or externally transmits radio frequency signals generated from the integrated circuit 20 connected to the front end module 10. The radio frequency signals received through the antenna 100 are transferred to the diplexer 110.

The diplexer 110 divides, or separates, the radio frequency signals transmitted and received through the antenna 100. In detail, the diplexer 110 separates the radio frequency signals transmitted and received through the antenna 100 into radio frequency signals in different bands. The diplexer 110 allows the radio frequency signals transferred from the antenna 100 or the radio frequency signals transferred from the integrated circuit 20 to pass through a low band and a high band to separate the radio frequency signals into radio frequency signals in different bands such as a high frequency band and a low frequency band. In this case, radio frequency signals in the low frequency band are transferred to the integrated circuit 20 through the filter 120, and radio frequency signals in the high frequency band are directly transferred to the integrated circuit 20. Here, the low frequency band may be a frequency band of 2.4 GHz, and the high frequency band may be a frequency band of 5 GHz. As an example, the diplexer 110 may be a thin film diplexer manufactured as a thin film.

The filter 120 is connected to the diplexer 110 to filter the radio frequency signals in the low frequency band transferred from the diplexer 110 and transfer the filtered radio frequency signals to the integrated circuit 20. When transmitting in the low frequency band the filter filters the radio frequency signals transferred from the integrated circuit and transfers the filtered radio frequency signals to the diplexer 110. The filter 120 serves as a band pass filter in order to pass radio frequency signals in a specific band therethrough. As an example, the filter 120 may include a film bulk acoustic resonator (FBAR) filter. As another example, the filter 120 may include a surface acoustic wave (SAW) filter.

The integrated circuit 20 receives the radio frequency signals in the low frequency band from the filter 120 and receives the radio frequency signals in the high frequency band from the diplexer 110, and processes the received radio frequency signals. In addition, the integrated circuit 20 generates the radio frequency signals and transfers the generated radio frequency signals to the antenna 100 directly through the diplexer 110 or to the antenna 100 through the filter 120 and the diplexer 110 to allow the generated radio frequency signals to be externally transmitted.

In a case in which the diplexer 110, described above, is a thin film diplexer and the filter 120 is an FBAR filter, a bypass path of electrostatic discharge (ESD) is not formed. Therefore, internal elements of the integrated circuit may be damaged due to the ESD abnormally introduced from external sources or from the within the front end module. Thus, the front end module 10 includes an inductor circuit 130 to bypass the ESD abnormally introduced externally or from within the front end module 10.

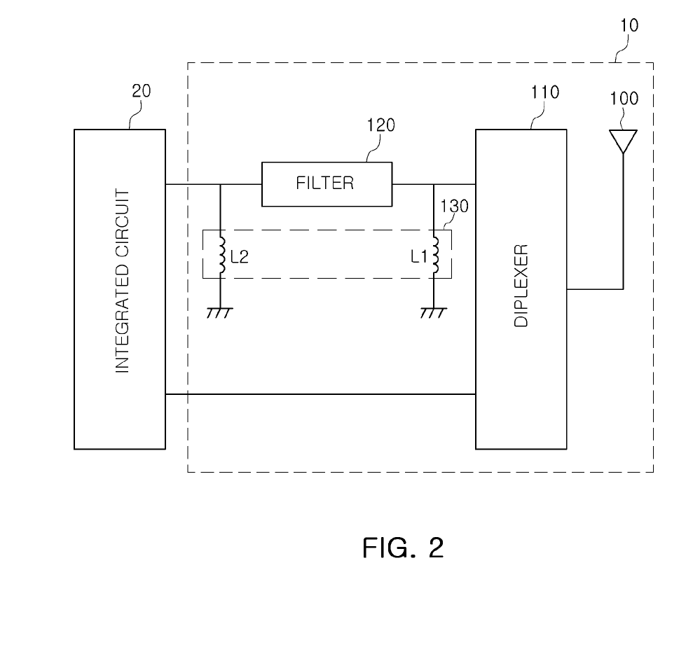

Referring to FIG. 2, the inductor circuit 130 includes at least two inductors, first inductor L1 and second inductor L2. The first inductor L1 and the second inductor L2 are disposed between two ends of the filter 120 and a ground, respectively. The first inductor L1 is disposed between a first connection node, located between the diplexer 110 and the filter 120, and the ground. The second inductor L2 is disposed between a connection node between the filter 120 and the integrated circuit 20 and the ground.

The first inductor L1 bypasses signals of ESD components that are introduced from the antenna 100 through the diplexer 110 to the ground, and the second inductor L2 bypasses signals of ESD components that are introduced from the integrated circuit 20 to the ground. Thus, in the front end module 10, the signals of ESD components abnormally introduced from external sources or from the inside of the front end module 10 are bypassed to the ground to prevent damage to internal elements of the integrated circuit 20.

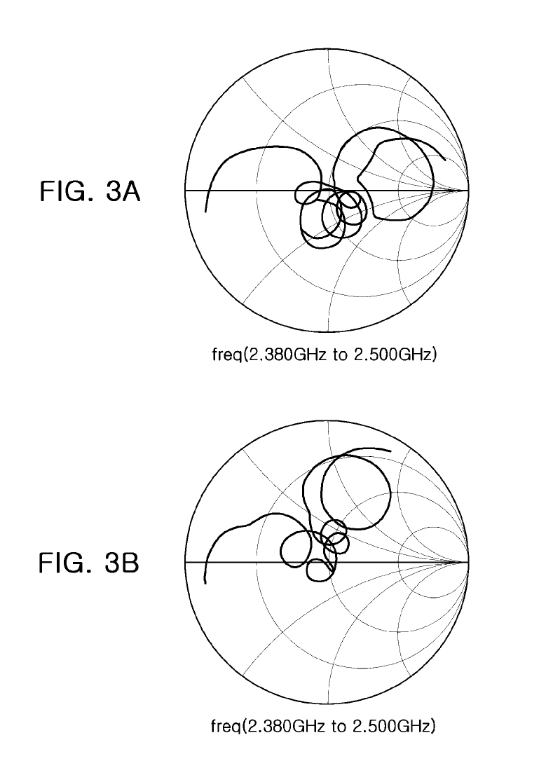

In addition, in the front end module 10, the first inductor L1 and the second inductor L2 match impedances of the radio frequency signals to each other and improve insertion loss and return loss characteristics of the radio frequency signals. Hereinafter, impedance matching and improvement of insertion loss and return loss characteristics according to an embodiment will be described with reference to FIGS. 3A through 5.

FIG. 3A is a Smith chart according to a Comparative Example corresponding to a front end module without the inductor circuit 130, and FIG. 3B is a Smith chart according to an example corresponding to a front end module with the inductor circuit 130.

In the Smith charts of FIGS. 3A and 3B, center impedances were 50Ω, impedances were measured using radio frequency signals in a band of 2.38 GHz to 2.5 GHz, and inductance values of the first inductor L1 and the second inductor L2 were 5.6 nH.

Referring to the Smith chart of FIG. 3A, the impedances of radio frequency signals are significantly out of range of 50Ω. Referring to the Smith chart of FIG. 3B, impedances are in the vicinity of 50Ω.

In the case in which the filter 120 of the front end module 10 described above is a FBAR filter, the FBAR filter may be a printed circuit board. However, a parasitic capacitance component may be inevitably present in the printed circuit board. As the parasitic capacitance component present in the printed circuit board becomes large, the radio frequency signals move from the center of the Smith chart to a lower left end of the Smith chart, and thus impedances occurs as illustrated in FIG. 3A.

Inductances of the first inductor L1 and the second inductor L2 compensates for the parasitic capacitance component present on the printed circuit board. Referring to FIG. 3B, impedances of the radio frequency signals are positioned in the vicinity of 50Ω, and thus the impedances match each other. Here, inductance values of the first and second inductors L1 and L2 are determined by the parasitic capacitance value of the FBAR filter.

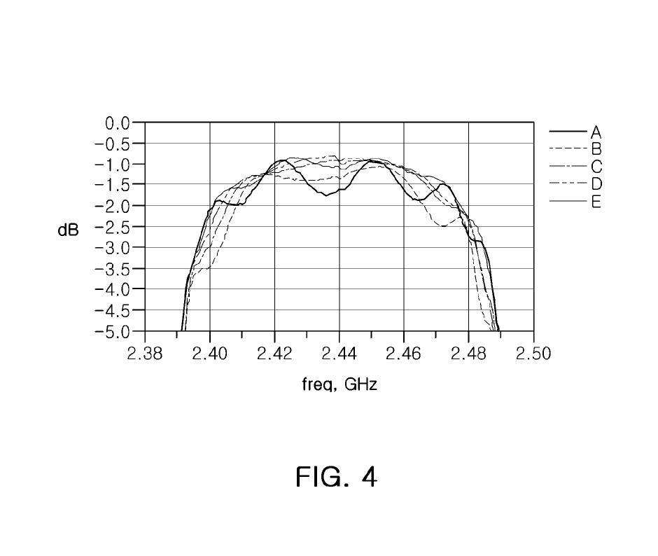

Referring to FIG. 4, line A represents a radio frequency signal according to the Comparative Example, corresponding to a front end module wherein an inductor circuit is not used. Lines B to E of FIG. 4 represent radio frequency signals according to examples corresponding to front end modules 10 having inductor circuits 130 including first and second inductors L1 and L2 each having inductance values of 3.3 nH, 4.7 nH, 5.6 nH, and 10 nH, respectively.

Referring to FIG. 4, insertion loss of the radio frequency signal of line A is at most 2.0 dB. The smallest insertion loss among lines B to E may be obtained from the radio frequency signal of line D, and the largest insertion loss among lines B to E may be obtained from the radio frequency signal of line E. Here, insertion loss of the graph of the radio frequency signal of line D is at most 0.5 dB, and insertion loss of the graph of the radio frequency signal of line E is at most 1.0 dB. When comparing the Comparative Example with the examples having an inductor circuit 130, the insertion loss characteristics of the examples having an inductor circuit are improved. Thus, in a front end module 10 having an inductor circuit 130 a ripple is decreased and a maximum channel deviation is decreased, as compared to the Comparative Example of a front end module without the inductor circuit 130.

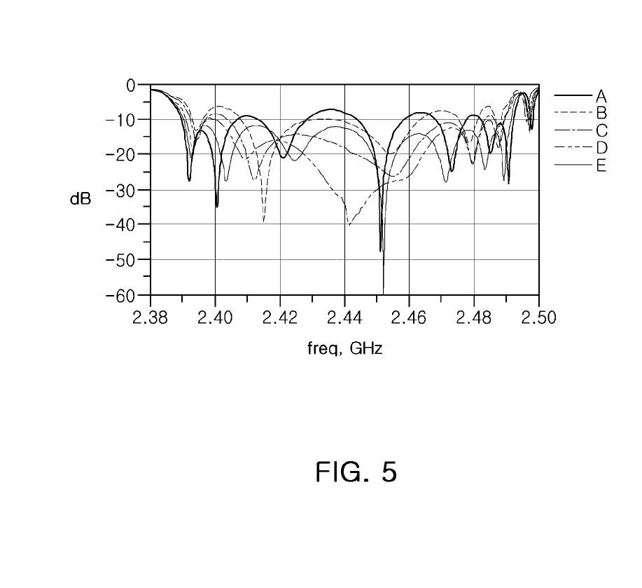

In reference to FIG. 5, line A represents a radio frequency signal according to the Comparative Example corresponding to the case in which the inductor circuit 130 is not used in the front end module 10. Lines B to E of FIG. 5 represent radio frequency signals according to examples of a front end module 10 having an inductor circuit 130, wherein the first and second inductors L1 and L2 of the inductor circuit 130 each have inductance values of 3.3 nH, 4.7 nH, 5.6 nH, and 10 nH respectively.

In the radio frequency signal of line A and the radio frequency signal of line E, return loss in a band of 2.44 GHz to 2.46 GHz is larger than −10 dB, and thus performance is deteriorated. However, according to line D, return loss in an entire frequency band is −10 dB or less, and thus return loss characteristics are improved.

As set forth above, the ESD introduced to a front end module 10 from an external source or from the inside of the front end module is bypassed, and thus damage to the internal elements of the integrated circuit is prevented. In addition, impedances of radio frequency signals are matched to each other, and return loss and insertion loss is improved.

The apparatuses, units, modules, devices, and other components illustrated in FIGS. 1-2 that perform the operations described herein are implemented by hardware components. Examples of hardware components include diplexers, controllers, sensors, generators, drivers, memories, comparators, arithmetic logic units, adders, subtractors, multipliers, dividers, integrators, and any other electronic components known to one of ordinary skill in the art. In one example, the hardware components are implemented by computing hardware, for example, by one or more processors or computers. A processor or computer is implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices known to one of ordinary skill in the art that is capable of responding to and executing instructions in a defined manner to achieve a desired result. In one example, a processor or computer includes, or is connected to, one or more memories storing instructions or software that are executed by the processor or computer. Hardware components implemented by a processor or computer execute instructions or software, such as an operating system (OS) and one or more software applications that run on the OS, to perform the operations described herein. The hardware components also access, manipulate, process, create, and store data in response to execution of the instructions or software. For simplicity, the singular term “processor” or “computer” may be used in the description of the examples described herein, but in other examples multiple processors or computers are used, or a processor or computer includes multiple processing elements, or multiple types of processing elements, or both. In one example, a hardware component includes multiple processors, and in another example, a hardware component includes a processor and a controller. A hardware component has any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

As a non-exhaustive example only, a terminal/device/unit as described herein may be a mobile device, such as a cellular phone, a smart phone, a wearable smart device (such as a ring, a watch, a pair of glasses, a bracelet, an ankle bracelet, a belt, a necklace, an earring, a headband, a helmet, or a device embedded in clothing), a portable personal computer (PC) (such as a laptop, a notebook, a subnotebook, a netbook, or an ultra-mobile PC (UMPC), a tablet PC (tablet), a phablet, a personal digital assistant (PDA), a digital camera, a portable game console, an MP3 player, a portable/personal multimedia player (PMP), a handheld e-book, a global positioning system (GPS) navigation device, or a sensor, or a stationary device, such as a desktop PC, a high-definition television (HDTV), a DVD player, a Blu-ray player, a set-top box, or a home appliance, or any other mobile or stationary device capable of wireless or network communication. In one example, a wearable device is a device that is designed to be mountable directly on the body of the user, such as a pair of glasses or a bracelet. In another example, a wearable device is any device that is mounted on the body of the user using an attaching device, such as a smart phone or a tablet attached to the arm of a user using an armband, or hung around the neck of the user using a lanyard.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A front end module comprising:
an antenna configured to transmit and receive radio frequency signals;
a diplexer configured to separate the radio frequency signals transmitted and received through the antenna into different frequency bands;
a filter connected to the diplexer; and
an inductor circuit comprising at least two inductors respectively disposed between an end of the filter and a ground.

2. The front end module of claim 1, wherein the inductor circuit comprises:
a first inductor connected between an end of the filter and the ground; and
a second inductor connected between another end of the filter and the ground.

3. The front end module of claim 2, wherein the first inductor is configured to bypass signals of electrostatic discharge components introduced from the antenna through the diplexer connected to an end of the filter, and
the second inductor is configured to bypass signals of electrostatic discharge components introduced from an integrated circuit connected to another end of the filter.

4. The front end module of claim 1, wherein the filter comprises a film bulk acoustic resonator filter.

5. The front end module of claim 4, wherein the inductor circuit is configured to compensate for a parasitic capacitance component due to the film bulk acoustic resonator filter to match impedances of the radio frequency signals to each other.

6. The front end module of claim 1, wherein inductances of the at least two inductors are determined to improve insertion loss characteristics or return loss characteristics, or both, of the radio frequency signals.

7. The front end module of claim 1, wherein the diplexer comprises a thin film diplexer.

8. The front end module of claim 1, wherein the diplexer is configured to separate the radio frequency signals into a low frequency band and a high frequency band.

9. The front end module of claim 8, wherein the diplexer is configured to transfer the radio frequency signals in the low frequency band to the filter.

10. The front end module of claim 8, wherein the diplexer is configured to bypass the filter and inductor circuit when transferring the radio frequency signals in the high frequency band to an integrated circuit.

11. A communications module comprising:
a front end module comprising:
an antenna configured to transmit and receive radio frequency signals,
a diplexer configured to separate the radio frequency signals into different bands,
a filter connected to the diplexer, and
an inductor circuit comprising at least two inductors each disposed between an end of the filter and a ground; and
an integrated circuit connected to the front end module.

12. The communications module of claim 11, wherein the integrated circuit comprises:
a low frequency band terminal connected to the filter; and
a high frequency band terminal connected to the diplexer.

13. The communications module of claim 11, wherein the inductor circuit comprises:
a first inductor connected between an end of the filter and the ground; and
a second inductor connected between another end of the filter and the ground.

14. The communications module of claim 13, wherein the first inductor is configured to bypass signals of electrostatic discharge components introduced from the antenna through the diplexer connected to an end of the filter, and
the second inductor is configured to bypass signals of electrostatic discharge components introduced from the integrated circuit connected to another end of the filter.

15. The communications module of claim 11, wherein the filter comprises a film bulk acoustic resonator filter.

16. The communications module of claim 15, wherein the inductor circuit is configured to compensate for a parasitic capacitance component due to the film bulk acoustic resonator filter in order to match impedances of the radio frequency signals to each other.

17. The communications module of claim 11, wherein inductances of the at least two inductors are determined to improve an insertion loss characteristic or a return loss characteristics, or both, of the radio frequency signals.

18. The front end module of claim 11, wherein the diplexer is configured to bypass the filter and inductor circuit when transferring the radio frequency signals in the high frequency band to the integrated circuit.
